(19) United States
(12) Patent Application Publication
(10) Pub. No.: US 2025/0280166 A1
(43) Pub. Date: Sep. 4, 2025

(54) ADAPTIVE DISPLAY OF AN ON-SCREEN RETICLE

(71) Applicant: DELL PRODUCTS L.P., Round Rock, TX (US)

(72) Inventors: Siew Fei Lee, Singapore (SG); Guo Lei, Singapore (SG); Wei-Kuo Yu, Singapore (SG)

(21) Appl. No.: 18/593,380

(22) Filed: Mar. 1, 2024

(51) Int. Cl. H04N 21/431; G09G 5/02; H04N 1/60

(52) U.S. Cl. CPC H04N 21/4316; G09G 5/02; H04N 1/6027; G09G 2300/0452; G09G 2320/0666; G09G 2340/06

(57) ABSTRACT

A display device creates an off-game hardware reticle and obtains red, green, and blue (RGB) values of pixels, sent by an information handling system from an area underneath the reticle. If the difference between an average of the RGB values and an RGB value of the reticle is less than a threshold, then the display device changes the RGB value of the reticle to a complementary color.

### FIELD OF THE DISCLOSURE

The present disclosure generally relates to information handling systems, and more particularly relates to an adaptive display of an on-screen reticle.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

A display device creates an off-game hardware reticle and obtains red, green, and blue (RGB) values of pixels, sent by an information handling system from an area underneath the reticle. If the difference between an average of the RGB values and an RGB value of the reticle is less than a threshold, then the display device changes the RGB value of the reticle to a complementary color.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram of a system configured for adaptively displaying an on-screen reticle, according to an embodiment of the present disclosure;

FIG. 3 is a flowchart illustrating a method for adaptive display of an on-screen reticle, according to an embodiment of the present disclosure;

FIGS. 4 and 5 are block diagrams of reticles superimposed over images, according to an embodiment of the present disclosure;

FIG. 6 is a block diagram of a system configured for adaptive display of an on-screen reticle, according to an embodiment of the present disclosure;

FIGS. 7 and 8 are block diagrams of composites that include a series of images for an adaptive display of an on-screen reticle, according to an embodiment of the present disclosure;

FIG. 9 is a flowchart illustrating a method for adaptive display of an on-screen reticle, according to an embodiment of the present disclosure; and

FIGS. 10 and 11 are block diagrams of reticles superimposed over images, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

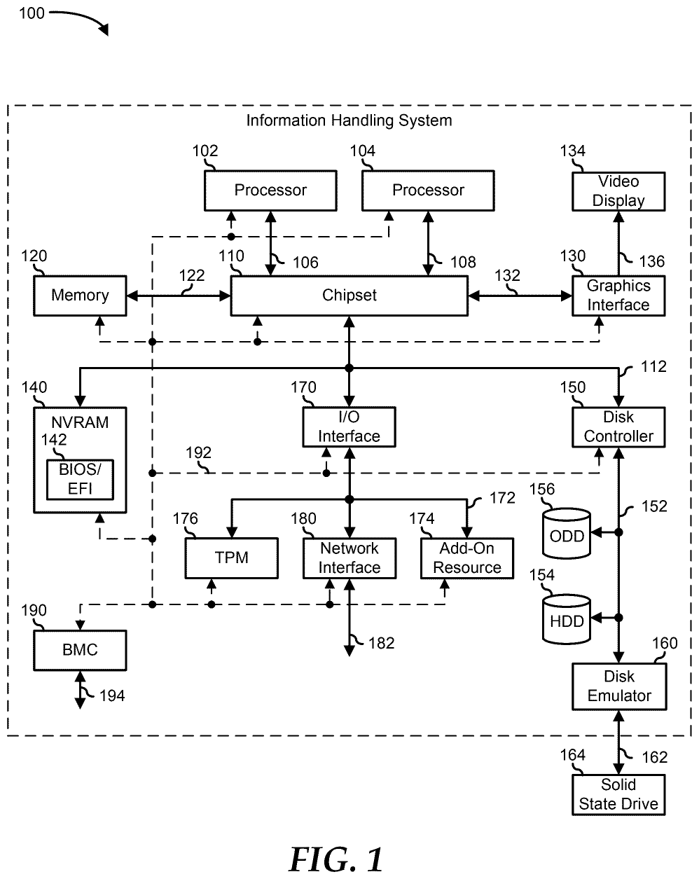

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (×4) PCIe adapter, an eight-lane (×8) PCIe adapter, a 16-lane (×16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board, or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172 and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include an Inter-Integrated Circuit (I2C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSS) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Here, information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I2C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

Off-game hardware reticles, such as crosshairs, are created to assist game players to aim and target game objects. For some implementations, in-game crosshairs have a single static color for the duration of a game. Because of this, the in-game crosshair may become difficult to distinguish from the backdrop of a scene as the color of the backdrop approaches the color of the in-game crosshair. Other game implementations include a backdrop that can overlap with the in-game crosshairs, thus hinder inga user's view of the gameplay. To address these and other concerns, the present disclosure provides a system and method for a real-time on-screen enhancement that maintains a consistently visible off-game hardware reticle both during the gameplay and outside of games without adding to CPU or graphics processing unit (GPU) rendering time. In particular, instead of the crosshair having a static single color, the present disclosure provides a system and method that is configured to provide an adaptive color-changing crosshair.

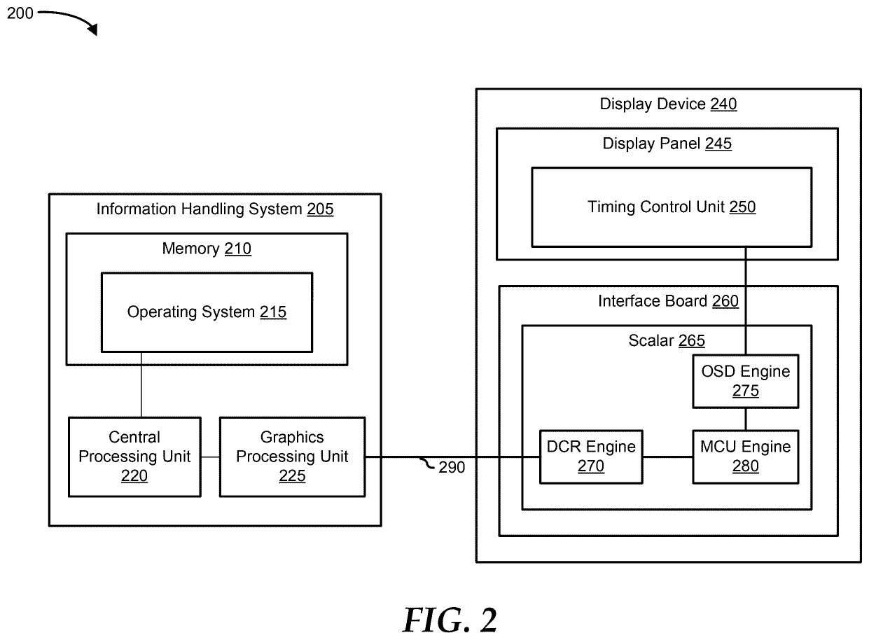

FIG. 2 shows a system 200 configured for adaptive display of an on-screen reticle. System 200 includes an information handling system 205 that is coupled to a display device 240 via an interface 290. Information handling system 205, which is similar to information handling system 100 of FIG. 1, includes a memory 210, a CPU 220, and a GPU 225. Memory 210 includes an operating system 215. Display device 240 includes a display panel 245 and an interface board 260. Display panel 245 includes a timing control unit 250 while interface board 260 includes a scalar 265. The components of system 200 may be implemented in hardware, software, firmware, or any combination thereof. The components shown are not drawn to scale and system 200 may include additional or fewer components. In addition, connections between components may be omitted for descriptive clarity.

Information handling system 205 may be configured to generate visual information for display at display device 240. For example, CPU 220 may be configured to execute instructions from operating system 215 or another application. CPU 220 may also be configured to process information stored in memory 210. Memory 210, which is similar to memory 120 of FIG. 1, maybe a non-volatile memory that is configured to store operating system 215. Operating system 215 may be loaded during a boot process and enter a runtime environment. CPU 220, which is similar to processors 102 and 104, may be configured to execute code retrieved from memory 210, such as operating system 215. Although information handling system 205 is illustrated with a single CPU, other embodiments may each be configured identically, or to provide specialized processing operations.

CPU 220 may include any processor capable of executing program instructions. CPU 220 may be communicatively coupled to operating system 215 and GPU 225. Accordingly, GPU 225 may be configured to interface with CPU 220 to process information for communication to display device 240. Generally, GPU 225 generates pixel values that pixels at display panel 245 present as colors so that the accumulation of the pixels presents a visual image. GPU 225 is coupled to display device 240 via interface 290. Interface 290 can be an HDMI, DisplayPort™, USB, USB type-C, video graphics array (VGA), or similar interface. However, any variety of connections between GPU 225 and scalar 265 are envisioned as falling within the scope of the present disclosure.

Display device 240 may be integrated into information handling system 205, such as where information handling system 205 is a laptop, tablet, 2-in-1 convertible device, mobile device, or similar. Display device 240 may also be an external display device that is coupled to information handling system 205, such as a computer monitor. Display device 240 includes an interface board 260 that is configured to receive image data from GPU 225, process the received data via scalar 265, and transmit the processed image data to display panel 245. Display panel 245 may be a light-emitting diode (LED) panel, an organic LED panel, a liquid crystal display panel, or other display technologies. Display panel 245 includes a timing control unit 250 that may be configured to receive and process pixel data from scalar 265.

Interface board 260 includes a scalar 265 that may be configured to convert different video signals, such as HDMI, DisplayPort™, USB-C, and VGA video signals, into a format that can be used to render content on display panel 245. Scalar 265 may include image processing capabilities to manipulate how the content is rendered. Scalar 265 includes a dynamic contrast ratio (DCR) engine 270, a microcontroller unit (MCU) engine 280, and an on-screen display (OSD) engine 275. DCR engine 270 may be configured to utilize local zone chromaticity analysis to analyze content, such as an image or frame. In particular, DCR engine 270 may be configured to collect red, green, and blue (RGB) values from pixels beneath a reticle, such as a crosshair, and calculate one or more average values from the collected RGB values, which provide an understanding of the visual context beneath the reticle.

Subsequently, MCU engine 280 may be configured to process the average value(s) of the RGB values and conduct a comparison against predefined conditions to make informed decisions regarding crosshair color adaptation. For example, MCU engine 280 may compare the average RGB value of an image or video frame with the RGB value of the reticle, and MCU engine 280 may determine if it is desirable to change the RGB value of the reticle or not. If MCU engine 280 determines that it is desirable to change the color of the reticle, MCU engine 280 may trigger OSD engine 275 to perform an action. Otherwise, MCU engine 280 may perform another comparison. OSD engine 275 may be configured to update the color of the reticle based on the visual context underneath when triggered. In particular, OSD engine 275 may be configured to adaptively transform the color of the reticle into a complementary color of the average RGB value over the image or video frame. This allows the user to see the crosshair against the backdrop in real-time. As such, as the crosshair moves during gameplay, the color of the crosshair may change adaptively based on the colors of a scene on display.

Those of ordinary skill in the art will appreciate that the configuration, hardware, and/or software components of system 200 depicted in FIG. 2 may vary. For example, the illustrative components within system 200 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

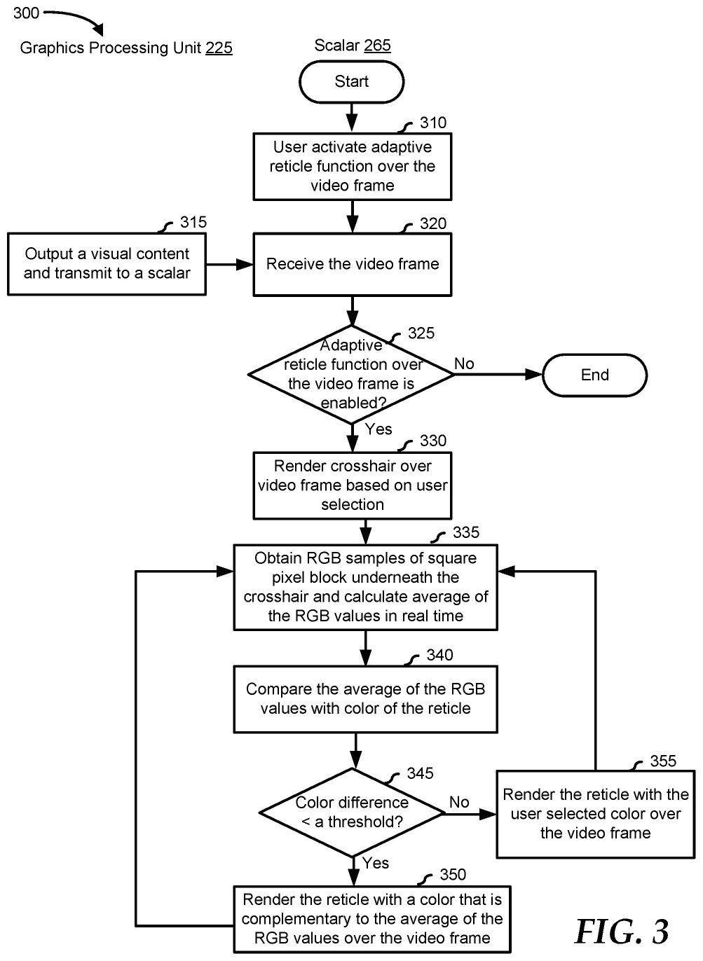

FIG. 3 shows a flowchart of a method 300 for an adaptive display of an on-screen reticle. Method 300 may be performed by any suitable component of system 200 of FIG. 2, including, but not limited to, GPU 225 and scalar 265. In particular, GPU 225 may be configured to perform block 315 while scalar 265 may be configured to perform the rest. While embodiments of the present disclosure are described in terms of the components of system 200 of FIG. 2, it should be recognized that other components may be utilized to perform the described method. Method 300 may be performed while an adaptive reticle function over a video frame is enabled by a user.

Method 300 typically starts at block 310 where the user may enable or activate the reticle function over the video frame. This enables the reticle to be overlaid on the content, such as an image or video frame, and succeeding contents until deactivated by the user. At this point, the user may choose or adjust one or more settings associated with the reticle, such as the location of the reticle, which by default is the center. Other settings include an initial color and shape of the reticle. In one example, the default color of the reticle is green with an RGB (0, 255, 0) while the default shape is a crosshair with a bar-cross shape which is represented as a pair of perpendicularly intersecting lines in the shape of a cross. Other variations of the reticle include dots, posts, chevrons, circles, squares, thruCross, barCross, etc.

At block 315, GPU 225 may output a content to be displayed, such as the video frame, and transmit the video frame to scalar 265. At block 320, scalar 265 may receive the content from GPU 225. The method may proceed to decision block 325 where scalar 265 may determine whether the adaptive reticle function over the video is enabled. If the reticle function over the video frame is enabled, then the “YES” branch is taken, and the method proceeds to block 330. If the reticle function over the video frame is disabled or deactivated by the user, then the “NO” branch is taken, and the method ends.

At block 330, scalar 265 or OSD engine 275 in particular may render the reticle over the content based on the settings selected by the user. The reticle may be rendered initially based on the user-selected settings. The method may proceed to block 335 where scalar 265 or DCR engine 270 in particular, may obtain samples of RGB values from pixels in a sample area. The sample area can be a square or any other form of pixel block underneath the reticle. Scalar 265 or DCR engine 270 may then calculate an average of the RGB values of the pixels in real-time. The size of the sample may be based on the selected reticle. For example, for a default crosshair with a bar-cross shape, the sample collected may have a size of 50×50 pixels. Accordingly, scalar 265 or DCR engine 270 in particular may output an average of the RGB values of 2500 pixels.

The method may proceed to block 340 where scalar 265 or MCU engine 280 in particular may compare the average of the RGB values with the RGB value of the reticle. The method may proceed to decision block 345 where scalar 265 or DCR engine 270 in particular may determine whether a color difference, also referred to as delta empfindung (delta E), between the color of the reticle and the average of the RGB values is less than a threshold. A delta E between three and six is generally considered an acceptable number in commercial reproduction. In particular, most people can distinguish the difference when the delta E is above five. As such, the threshold may be set to a value between three and six, such as five. However, the threshold may be set to a different number. The threshold can also be set to different individual values for R, G, and B. If the color difference is less than the threshold, then the “YES” branch is taken, and the method proceeds to block 350. If the color difference is not less than the threshold, then the “NO” branch is taken, and the method proceeds to block 355.

At block 350, scalar 265, or OSD engine 275 in particular, may render the reticle with a color that is complementary to the average RGB values over the video frame. The complementary color may be chosen to create a contrast to the average RGB values for a striking optical effect, which allows the reticle to be “always visible.” At block 355, scalar 265, or OSD engine 275 in particular, may render the reticle with the user-selected color over the video frame.

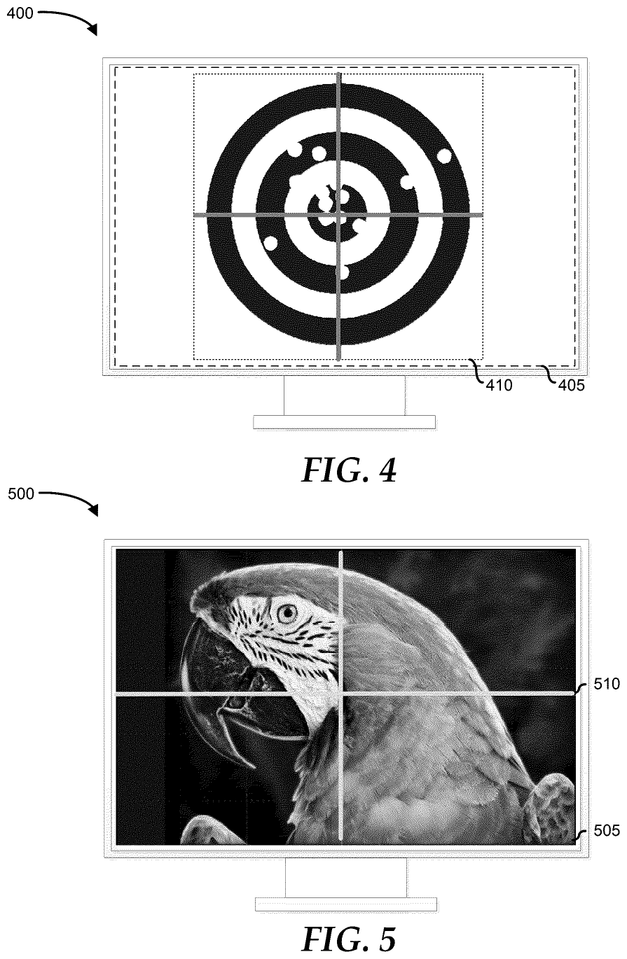

FIG. 4 shows a display device 400 with a reticle 410 superimposed over an image 405. In this example, the color of reticle 410 may change based on an average color of image 405 underneath. In particular, the color of reticle 410 may be a complementary color of the average color. In addition, the color of reticle 410 may change adaptively as reticle 1010 is moved around, and the average color of the image underneath changes. This color inversion of the reticle is also depicted in FIG. 5 which shows a display device 500 with a reticle 510 superimposed over an image 505.

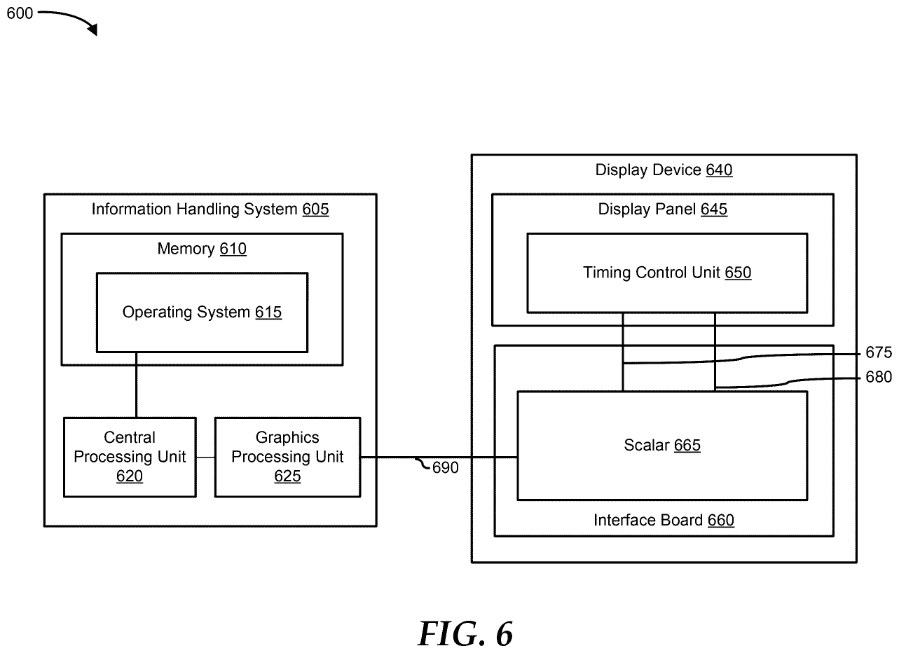

FIG. 6 shows a system 600 for an adaptive display of an on-screen reticle. System 600 includes an information handling system 605 that is coupled to a display device 640 via an interface 690. Information handling system 605, which is similar to information handling system 205 of FIG. 2, includes a memory 610, a CPU 620, and a GPU 625. Memory 610 includes an operating system 615. Display device 640 includes a display panel 645 and an interface board 660. Display panel 645 includes a timing control unit 650. Interface board 660 includes a scalar 665. Scalar 665 includes a primary video path 675 and a secondary video path 680. Display panel 645 is similar to display panel 245 of FIG. 2. Timing control unit 650 is similar to timing control unit 250 of FIG. 2. Scalar 665 is similar to scalar 265 of FIG. 2. Memory 610 is similar to memory 210 of FIG. 2. CPU 620 is similar to CPU 220 of FIG. 2. GPU 625 is similar to GPU 225 of FIG. 2. The components of system 600 may be implemented in hardware, software, firmware, or any combination thereof. The components shown are not drawn to scale and system 600 may include additional or fewer components. In addition, connections between components may be omitted for descriptive clarity.

Display device 640 is similar to display device 240 of FIG. 2. However, display device 640 also has a picture-in-picture (PIP) and/or picture-by-picture (PBP) capability which allows a primary content to be presented via a primary window while secondary content may be presented via a secondary window. In one example, the secondary window may be the PIP or PBP window that can be superimposed or overlaid on the primary window. A primary video path 675, also referred to as a main video path may be used for displaying a primary content, such as content from GPU 625. The content from GPU 625 can be an image, video frame, video stream, or similar. A secondary video path also referred to as an auxiliary video path, may be used for displaying auxiliary video content, also referred to as the secondary video content. Accordingly, scalar 665 may be configured to leverage the PIP/PIP functionality of display device 640 and present a reticle in the secondary window via the secondary video path 680. For example, the reticle may be rendered as an overlay PIP window on the primary content. The primary content may be presented via primary video path 675. Thus, scalar 665 may be configured to leverage the utilization of the dual video path process function when the visible display on-screen reticle is enabled.

In one embodiment, the reticle may be presented using a filtered mask layer as an overlay on the primary content creating a visual effect. In particular, scalar 665 may be configured to create a mask layer that adopts the reticle's contour. The mask layer can be combined with a filter that includes the reticle. The combination may be rendered at the secondary window via secondary video path 680 and superimposed over the primary content or a portion thereof which is rendered at the primary window via primary video path 675. For example, the combination may be rendered using the PIP/PBP functionality of display device 640. The filtered mask layer may provide an exclusive OR (XOR) function resulting in color inversion. In particular, the combination results in a pixel-by-pixel visual effect, wherein RGB values of the pixels of the reticle may change to complement the RGB values of the pixels underneath the reticle, such as depicted in images 725 and 735.

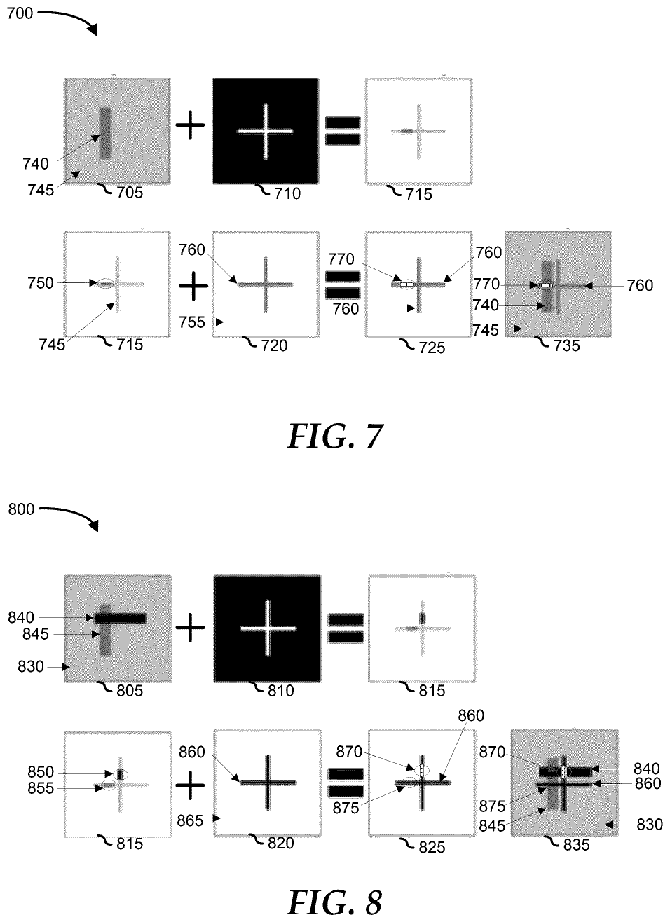

FIG. 7 shows a composite 700 that includes a series of images for an adaptive display of an on-screen reticle. Composite 700 includes an image 705, a mask 710, a masked image 715, a filter 720, an image 725, and an image 735. Image 705 may be an image presented via a primary video path. Mask 710 and filter 720 may be linked or combined, such that when the on-screen reticle is moved, mask 710 and filter 720 may move together. Image 705 may be primary content, such as a scene generated by an application like a gaming application. Image 705 includes a background 745 and an object 740, wherein the color of background 745 may be different than the color of object 740. In this example, object 740 has an RGB color green (0×00FF00).

Mask 710 may be a mask layer of an area based on the size of the reticle, wherein the area of the mask layer is greater than the area of the reticle. Further, image 705 may have an area that is larger than mask 710. Mask 710 includes a pattern of a pre-defined shape of the reticle, as selected by the user. In this example, mask 710 includes a pre-defined crosshair with a bar-cross shape. The pattern may be translucent on an opaque base. Accordingly, mask 710 may be applied to image 705, such that the color of pixels underneath mask 710 may be concealed except for the pixels underneath the pattern. For example, mask 710 may be overlaid on image 705 resulting in masked image 715. In this example, masked image 715 shows a portion of background 745 and a portion 750 of object 740 through the pattern. As such, portion 750 may include pixels of object 740 underneath the reticle pattern of mask 710.

Filter 720, with an area that is similar to the area of mask 710, may be applied to masked image 715 resulting in image 725. For example, filter 720 may be overlaid or superimposed on masked image 715. Filter 720 may include an RGB white (0×FFFFFF) as a base layer 755 and a reticle 760 which is based on the user-selected shape and color. The color and shape of the reticle may be preselected by the user during the activation of the reticle function over the video frame. In this example, reticle 760 has a color similar to the RGB color green (0×00FF00). Because object 740 and reticle 760 have similar colors, a portion of reticle 760 that overlaps portion 750 may “disappear” against the backdrop. To mitigate this issue, filter 720 may have been designed to change the colors of the pixels of the portion of reticle 760 that overlaps portion 750 to complement the colors of the pixels underneath said portion of reticle 760 resulting in a desired multi-color effect. This may increase the visibility of the overlapping portion of reticle 760 with portion 750. For example, the combination of RGB white (0×FFFFFF) of filter 720 when overlaid against the RGB green (0×00FF00) of portion 750 of object 740 may result in an XORed value of RGB magenta (0×FF00FF) of portion 770 of reticle 760, which is a complementary color of RGB green (0×00FF00). Portion 770 is a portion of reticle 760 that may be superimposed over portion 750. In this example, the color of portion 770 may be complementary to the color of portion 850. Portion 770 is shown with the visual effects. This visual effect of portion 770 of reticle 860 over image 705 is also depicted in image 735. This visual effect of reticle 760 over image 705 is depicted in image 735.

FIG. 8 shows a composite 800 that includes a series of images for an adaptive visible display on-screen reticle. Composite 800 includes an image 805, a mask 810, a masked image 815, a filter 820, an image 825, and an image 835. Similar to above, mask 810 and filter 820 may be linked, such that when the on-screen reticle is moved, mask 810 and filter 820 may move together. Image 805 may be an image, scene, video stream, etc. that is generated by an application, such as a gaming application, and rendered via a primary video path. Image 805 includes a background 830, an object 840, and an object 845, wherein the color of background 830 may be different than the color of objects 840 and 845. In this example, object 845 has an RGB color green (0×00FF00) while object 840 has an RGB color black (0×000000).

Mask 810 may be a mask layer with an area generally larger than the size and/or area of the reticle. Further, image 805 may have an area that is generally larger than the area of mask 810, wherein the area of image 805 may be up to the resolution of the display. Mask 810 may include a base and a pattern of a pre-defined shape of the reticle, as selected by the user. In this example, the pattern is a crosshair with a bar-cross shape. Similar to mask 810, the base of mask 810 may have an opaque color such that the color of the pixels underneath the portion of mask 810 with the opaque color may be concealed. In addition, similar to mask 810, the pattern may have a transparent color such that the color of the pixels underneath the pattern may be revealed. In this example, mask 810 may be overlaid on image 805 resulting in masked image 815. Masked image 815 may reveal a portion 855 of object 845, a portion 850 of object 840, and a portion of background 830 underneath the pattern. As such, portion 850 may reveal the colors of the pixels of object 840 while portion 855 may reveal the colors of the pixels of object 845.

Filter 820, with an area that is similar to the area of mask 810, may be applied to masked image 815 resulting in image 825. For example, filter 820 in combination with mask 810 may be overlaid on masked image 815. Filter 820 may include a base 865 with an RGB white (0×FFFFFF) and a reticle 860 according to the user-selected shape and color. The color and shape of the reticle may be selected by the user during the activation of the reticle function over the video frame. In this example, reticle 860 has a color similar to the RGB color black (0×000000) of object 840. Because object 840 and reticle 860 have similar colors, a portion of reticle 860 that overlaps portion 850 may “disappear” against the backdrop.

To mitigate this issue, filter 820 may have been designed to complement the colors of the pixels underneath reticle 860 resulting in a desired multi-color effect. This may then increase the visibility of the overlapping portion of reticle 860 with portion 850. For example, the combination of RGB white (0×FFFFFF) of filter 820 when overlaid against the RGB black (0×000000) of object 840 may result in an XORed value of RGB white (0×FFFFFF) for portion 870, which is a complementary color of RGB black (0×000000). Portion 870 is a portion of reticle 860 that may be superimposed over portion 850. In this example, the color of portion 870 may be complementary to the color of portion 850. Portion 870 is shown with the visual effects. This visual effect of portion 870 of reticle 860 over image 805 is also depicted in image 835. Because the color of portion 855 is different than object 845, the color of pixels associated with portion 855 may not be inverted as depicted in portion 875.

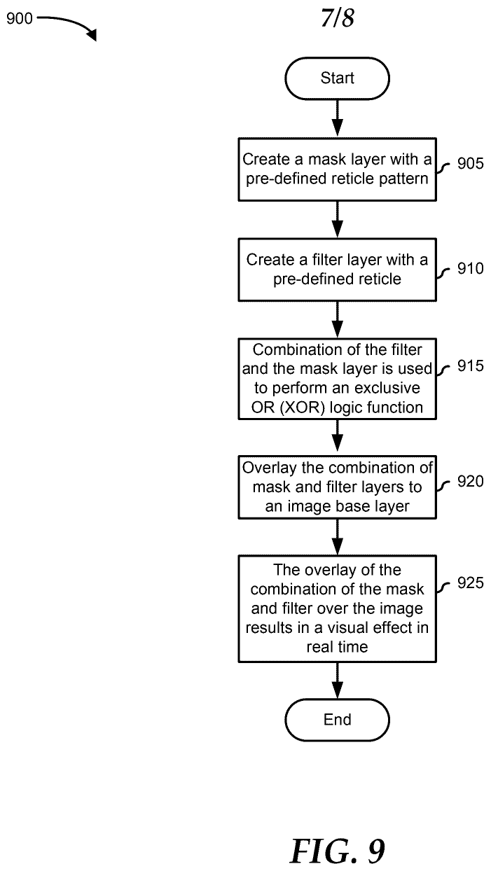

FIG. 9 shows a flowchart of a method 900 for an adaptive display of an on-screen crosshair. Method 900 may be performed by any suitable component of system 600 of FIG. 6, including, but not limited to scalar 665. While embodiments of the present disclosure are described in terms of the components of system 600 of FIG. 6, it should be recognized that other components may be utilized to perform the described method. Method 900 may be performed while an adaptive reticle function over a video frame is enabled by a user.

Method 900 typically starts at block 905 where scalar 665 creates a mask layer with a predefined reticle, which may mask out images in the background outside of the reticle. The shape and/or color of the reticle may be selected by the user. For example, the user may use the provided default shape and color. In another example, the user may select a shape and color other than the provided defaults. The method may proceed to block 910.

At block 910, scalar 665 may create a filter layer with a pre-defined reticle. The filter layer may be combined with the mask layer to perform an XOR logic function at block 915. The method may proceed to block 920 where scalar 665 may overlay the mask with the filter layer to an image base layer. The method may then proceed to block 925 where scalar 665 may present a visual effect of the superimposed combination mask and filter over the image base layer in real-time.

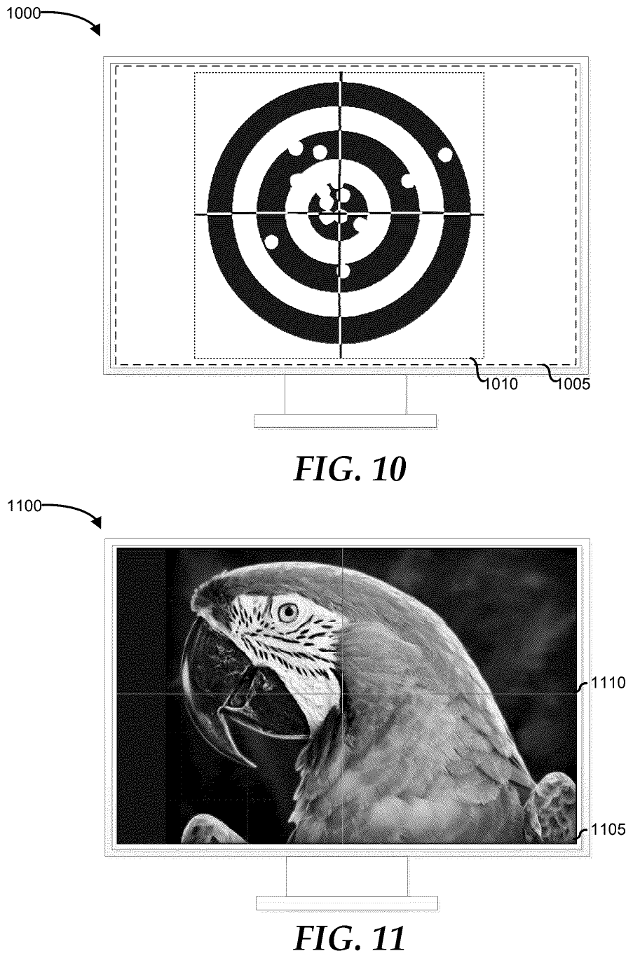

FIG. 10 shows a display device 1000 with a reticle 1010 superimposed over an image 1005. In this example, the color of reticle 1010 may change pixel by pixel based on the color of the primary content underneath, wherein the color of the pixels of reticle 1010 may be complementary to the color of the image's pixels underneath. For example, in areas where the color of the image is white, the color of a portion of the reticle over the said area is black. Accordingly, in areas where the color of the image is black, the color of the portion of the reticle over the said area is white. In addition, the color of the pixels of reticle 1010 may change adaptively as reticle 1010 is moved around. This pixel-by-pixel color inversion of the reticle is also depicted in FIG. 10 which shows a display device 1100 with a reticle 1110 superimposed over an image 1105.

Although FIG. 3, and FIG. 9 show example blocks of method 300 and method 900 in some implementations, method 300 and method 900 may include additional blocks, fewer blocks, different blocks, or differently arranged blocks than those depicted in FIG. 3 and FIG. 9. Those skilled in the art will understand that the principles presented herein may be implemented in any suitably arranged processing system. Additionally, or alternatively, two or more of the blocks of method 300 and method 900 may be performed in parallel. For example, blocks 330 and 335 of method 300 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
obtaining, by a processor, red, green, and blue (RGB) values of pixels from an area underneath a reticle;
calculating an average of the RGB values of the pixels from the area underneath the reticle; and
if a difference between the average of the RGB values and an RGB value of the reticle is less than a threshold, then changing the RGB value of the reticle to a complementary color for display.

2. The method of claim 1, further comprising comparing the average of the RGB values with the RGB value of the reticle.

3. The method of claim 1, further comprising if the difference between the average of the RGB values and the RGB value of the reticle is less than the threshold, then displaying the reticle using the RGB value.

4. The method of claim 1, wherein the RGB value of the reticle is selected by a user.

5. The method of claim 1, wherein the area includes 50 pixels by 50 pixels.

6. The method of claim 1, wherein the threshold is a delta empfindung value.

7. The method of claim 1, wherein the method is performed subsequent to a user activating the reticle.

8. A display device, comprising:
a display panel configured to display a reticle; and
a scalar configured to:
obtain red, green, and blue (RGB) values of pixels from an area underneath the reticle;
calculate an average of the RGB values of the pixels from the area underneath the reticle; and
if a difference between the average of the RGB values and an RGB value of the reticle is less than a threshold, then display the reticle using a complementary color of the RGB value.

9. The display device of claim 8, wherein the scalar is further configured to compare the average of the RGB values with the RGB value of the reticle.

10. The display device of claim 8, wherein the scalar is further configured to determine if the difference between the average of the RGB values and the RGB value of the reticle is less than the threshold, then displaying the reticle using the RGB value.

11. The display device of claim 8, wherein the RGB value of the reticle is selected by a user.

12. The display device of claim 8, wherein the threshold is a delta empfindung value of five.

13. A method comprising:
receiving, by a processor, an image for display;
superimposing a mask over the image resulting in a masked image; and
applying a filter that includes a reticle of a red, green, and blue (RGB) value to the masked image resulting in inversion of RGB values of pixels of the reticle that overlaps the image.

14. The method of claim 13, wherein the mask includes pre-defined contours of the reticle.

15. The method of claim 13, wherein the inversion of the RGB values of the pixels of the reticle is performed pixel by pixel.

16. The method of claim 13, wherein the inversion of the RGB values of the pixels of the reticle that overlaps the image resulting in a visual effect unto the reticle.

17. The method of claim 13, wherein the inversion of the RGB values of the pixels is performed in real-time.

18. The method of claim 13, wherein a base of the filter has an RGB value of white.

19. The method of claim 13, wherein the mask and the filter are displayed at a picture-in-picture window.

20. The method of claim 13, wherein the image is displayed via a main video path.
